(19) United States
(12) Patent Application Publication
(10) Pub. No.: US 2008/0216424 A1
(43) Pub. Date: Sep. 11, 2008

(54) Window joining system

(76) Inventors: Dennis C. Westphal, Lebanon, IN (US); Jerome C. Habeck, Westfield, IN (US)

Correspondence Address: DUANE MORRIS, LLP;IP DEPARTMENT, 30 SOUTH 17TH STREET, PHILADELPHIA, PA, 19103-4196, US

(21) Appl. No.: 11/714,977

(22) Filed: Mar. 7, 2007

(51) Int. Cl. E06B 3/00

(52) U.S. Cl. 52/204.5; 52/656.5

(57) ABSTRACT

A mullion assembly is disclosed comprising a pair of complementary mullion clip portions, each configured to be self retaining or frictionally engaged to a pair of window frames. Each mullion clip portion is configured to snap into corresponding recesses in the first or second window frame without the need for additional fasteners. The clip portions include integrally formed thermal barrier tabs to block airflow between the window frames. The clip portions may also have self-aligning features such as correspondingly shaped projections and recesses formed in abutting surfaces of the clip halves to facilitate alignment and fit-up of the window frames. The mullion clips may also have barbs for engaging interior and exterior snap on covers that are used to cover the gap between the first and second window frames and form a finished outer appearance.

### CROSS-REFERENCE TO RELATED APPLICATION

This application is related to U.S. Pat. No. 6,662,512 to Westphal et al., and U.S. Pat. No. 6,360,498 to Westphal et al., the entire contents of which are incorporated herein by reference.

### FIELD OF THE INVENTION

The present invention generally relates to a system for joining adjacent window units within a single opening in a building structure, and more particularly to a reinforcing mullion device for enhancing structural rigidity of the assembly and for providing an integral thermal barrier against the weather.

### BACKGROUND OF THE INVENTION

Window frames traditionally have been made from wood or metal or various combinations of wood and metal. In recent years, windows formed with hollow metal or polymer frames have become popular, due to their improved thermal properties, lower cost and relative ease of manufacture, assembly and installation compared with traditional wood and metal windows. Such window assemblies may be limited in size by the requirement that they withstand design wind-loads as established by local building codes and ordinances. Another factor limiting the allowable size of multiple window assemblies is the fact that such assemblies are very often difficult to transport, handle, and install.

Windows made from various combinations of polymer and metal components are known. For example, U.S. Pat. No. 5,435,106 discloses a window assembly including adjacent first and second windows and a reinforcing mullion connecting the windows. The mullion comprises hollow polymeric first and second lineals and a single metal reinforcing bar fastened between the lineals. Interior and exterior face caps attached to the lineals span a gap between them. A steel plate, two high strength steel bolts or posts, and several wood screws are provided for connecting an end portion of the metal reinforcing bar to a support structure surrounding the window opening in the building. The mullion adds rigidity to the assembly, thereby allowing for an increase in its allowable size. Other prior designs have also provided similar structures to add rigidity to a window assembly, e.g., U.S. Pat. Nos. 6,014,846; 5,937,597; and 4,981,001.

These and other windows generally suffer from one or more disadvantages making them less than entirely suitable. For example, windows of these types are often arranged in multiple window assemblies. Such assemblies can become quite large and heavy, making them difficult to handle, and thus making them less amenable to field installation. Accordingly, there is a need to provide windows with field assembleable reinforcements so that they are able to meet design standards economically, when several such windows are combined into a unitary assembly, and to be easily and economically assembled together in the field or factory.

There are occasions when it is desired to install more than one window unit into a single opening in a structure. One method is to use a structural mulling system that is fastened to each of the window units and is also fastened to the structure of the building. This is an accepted method that provides structural strength to the overall assembly because it is tied to the structure. In some cases that use window units that are smaller and/or do not require the strength of a formal mulling system, this system can be “overkill” as to function and cost. In these situations, it would be desirable to use a joining system that provides sufficient strength for the combined unit, but with an overall lower cost.

One current simplified technique for joining adjacent window units is to use small “U” shaped vinyl extrusions that clip into grooves located in the inner and outer window frame faces. Such clips are expected to provide limited strength to the combined assembly. Other techniques are disclosed in U.S. Pat. Nos. 6,360,498 and 6,662,512 to Westphal, which describe two-piece mullion arrangements that screw into the associated window frame members and which incorporate separate thermal barrier elements for preventing drafts between the windows from entering the living space.

It would be advantageous to provide a mullion design that reduces installation time, while not compromising the structural or thermal integrity of the connection between adjacent windows. Such a design would be screw-less, and would have an integral thermal barrier, thus speeding installation at the job site.

### SUMMARY OF THE INVENTION

A mullion reinforcement for use in forming an assembly of windows is disclosed. The mullion reinforcement may comprise, a first member lockable to a first recess of a first window frame, the first member having first and second projections engageable with first and second structures defining an opening of said first recess to lock said first member to said first recess of said first window frame. The mullion reinforcement may further comprise a second member lockable to a first recess of a second window frame, the second member having first and second projections engageable with first and second structures defining an opening of said first recess to lock said second member to said first recess of said second window frame. The first member further may comprise a first portion of a catch and the second member further may comprise a second portion of a catch that is complementary to said first portion of a catch so that when the first window frame is assembled to the second window frame said first member and said second member cooperate to form a catch.

A mullion assembly is disclosed, comprising a first mullion clip portion lockable to a first recess of a first window frame, the first mullion clip portion having first and second projections engageable with first and second structures defining an opening of the first recess to lock the first mullion clip portion to the first window frame. The mullion assembly may comprise a second mullion clip portion lockable to a first recess of a second window frame, the second mullion clip portion having first and second projections engageable with first and second structures defining an opening of the first recess of the second window frame to lock the second mullion clip portion to the second window frame. The first mullion clip portion may further comprise a first catch portion and the second mullion clip portion may further comprise a second catch portion complementary to said first catch portion so that when the first window frame is assembled to the second window frame the first and second mullion clip portions cooperate to form a catch.

A window assembly is disclosed, comprising a first window having a first window frame, a second window having a second window frame, and a mullion for connecting the first and second window frames. The mullion may comprise (a) a first mullion clip portion lockable to a first recess of the first window frame via a snap-fit; and (b) a second mullion clip portion lockable to a first recess of a second window frame via a snap-fit. The first and second mullion clip portions further may comprise respective first and second complementary catch portions so that when the first window frame is assembled to the second window frame the first and second mullion clip portions cooperate to form a catch. The window assembly may further comprise a cover configured to engage the catch of the first and second mullion clip portions to lock the halves together and seal a gap between the first and second frames, the cover having first and second spaced apart arms, each arm having a lip disposed on a first end thereof, the lips projecting into a recess defined by the arms for engaging corresponding shoulder regions of the catch when the cover is pressed onto the assembled first and second mullion clip portions.

A method of assembling a multi-window unit, comprising: providing first and second window frames, each of the first and second frames comprising first and second recesses; providing a first mullion clip assembly comprising: (a) a first member lockable to the first recess of the first window frame, the first member having first and second projections engageable with first and second structures defining an opening of the first recess of the second window frame to lock said first member to said first recess of said first window frame; (b) a second member lockable to the first recess of the second window frame, the second member having first and second projections engageable with first and second structures defining an opening of the first recess of the second window frame to lock said second member to said first recess of said second window frame; wherein the first member further comprises a first portion of a catch and the second member further comprises a second portion of a catch that is complementary to said first portion so that when the first window frame is assembled to the second window frame said first member and said second member cooperate to form a catch; providing a cover comprising first and second spaced apart arms, each arm having a lip disposed on a first end thereof, the lips projecting into a recess defined by the first and second spaced apart arms, the cover further having first and second lateral flanges connected to a second end of the first and second spaced apart arms; engaging the first member with the first recess of the first window frame; engaging the second member with the first recess of the second window frame; moving the first and second window frames together so that the first and second members connect to form the catch; aligning the first and second spaced apart arms with the catch formed by the first and second members; and pressing the cover against the catch so until the lips engage the catch and the first and second lateral flanges engage respective outer surfaces of the first and second window frames to seal a gap between the first and second window frames.

### BRIEF DESCRIPTION OF THE DRAWINGS

The accompanying drawings illustrate preferred embodiments of the invention so far devised for the practical application of the principles thereof, and in which:

FIG. 1 is a front elevation view of a window assembly made in accordance with the present invention.

FIG. 2A is a cross-section view of the inventive mullion assembly taken along line 2A-2A of FIG. 1, with the mullion clip halves and associated window units separated for clarity; FIGS. 2B and 2C are detail views of the exterior and interior portions, respectively, of a single clip half;

FIG. 3A is a cross-section view of the mullion assembly of FIG. 2A, showing the mullion clip halves engaged with respective window frame members, and the snap on covers in the uninstalled configuration; FIGS. 3B and 3C are detail views of the exterior and interior cover-engaging portions, respectively, of the clip halves;

FIG. 4A is cross-section view of the assembly of FIG. 2A, showing the mullion clip halves of the mullion clips engaged and the snap on covers installed; FIGS. 4B and 4C are cross-sectional views of the exterior and interior snap-on covers, respectively;

FIG. 5 is a cross-section view of an alternative mullion assembly, showing discrete interior and exterior mullion clips engaged with respective window frame members.

### DETAILED DESCRIPTION

This invention is generally composed of polymer profiles that when combined with a pair of window units provide a method of joining the units to each other to form a multi-window assembly. The assembly may then be installed in a single opening in a building structure. The profiles consist of a two-piece mullion clip, with a pair of snap on covers for locking the ends of the assembled clip together. The clip halves snap into cavities formed in each of the window units. The clip halves have complementary abutting surfaces with alignment projections/recesses that facilitate alignment of the window units when the two halves are brought together. The interlocking alignment projections/recesses also provide the window assembly with the strength to resist wind loads applied to the exterior faces of the window units in use. The snap on covers lock the clip halves together, which locks the window units together.

The inventive joining system may be applied to the window units without the need for mechanical fasteners (screws, staples etc), thus providing substantial savings in both material and labor costs.

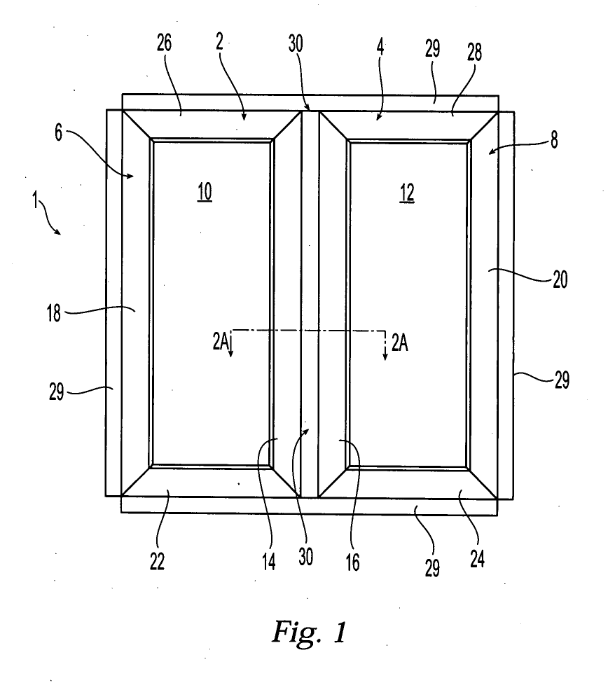

Typical window assemblies are often made up of two or more adjacent discrete window units, and are often generally rectangular. Each window unit generally comprises elongated stiles, a sill and a rail. Frames of the windows may be made from hollow, rigid extrusions that are formed from light weight metals or polymers. Referring to FIG. 1, a window assembly 1 includes first and second laterally adjacent window units 2, 4 having first and second frames 6, 8 supporting glass window panes 10, 12, respectively. Frames 6, 8 include inner jambs 14, 16 and outer jambs 18, 20 both connecting bottom sills 22, 24 to heads or rails 26, 28, respectively. First and second frames 6, 8 may also include a nailing flange 29. A centrally located mullion assembly 30 interconnects frames 6, 8 to form window assembly 1, and to improve structural rigidity.

It will be understood that the present invention is in no way limited to a two window unit assembly, and may thus be used in multiple window assemblies. Also, the inventive two-piece mullion may be suitable for use with other types of window assemblies, including, but not limited to, sliding sash windows, picture windows, awning windows, jalousie windows, tilt and turn windows and patio doors of all types.

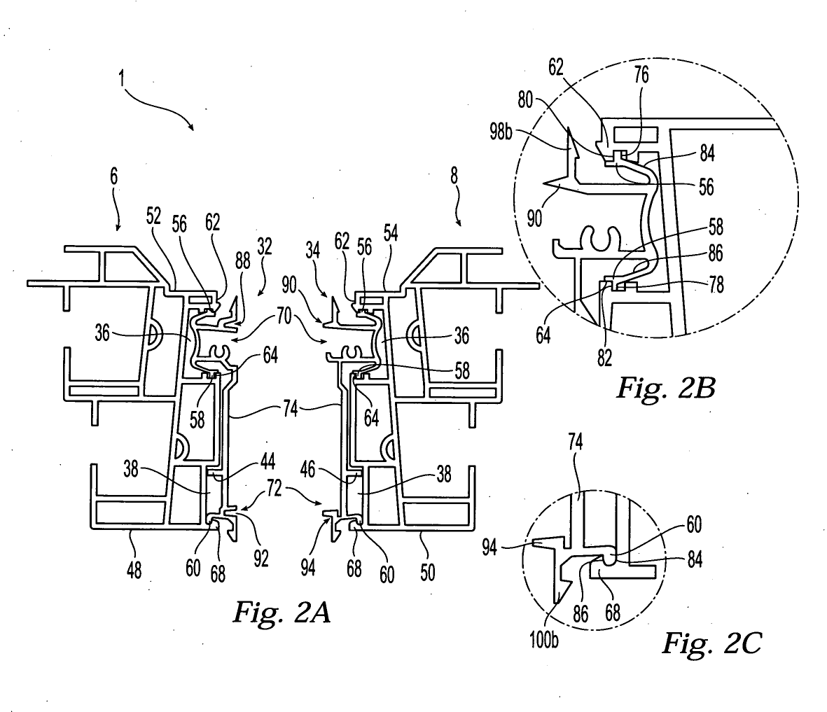

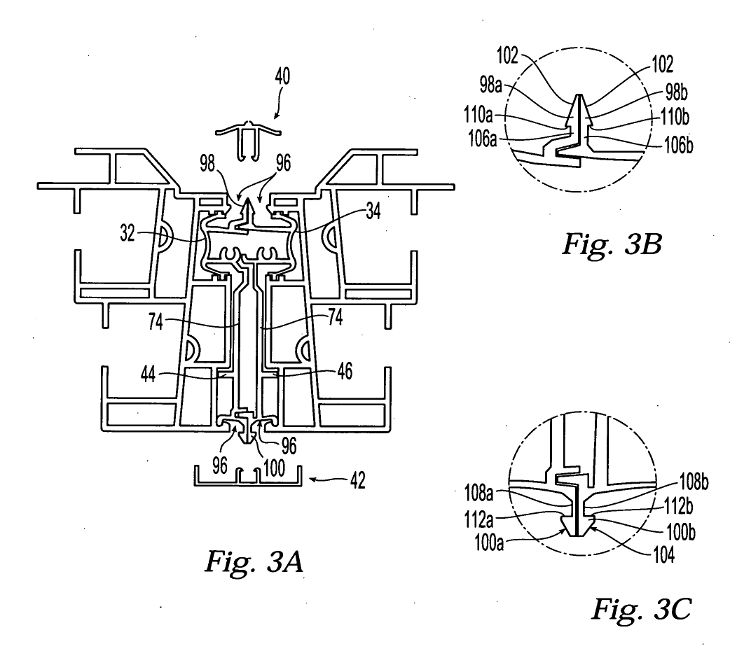

Referring now to FIG. 2A, the mullion assembly 30 may comprise first and second mullion clip halves 32, 34 for interconnecting the first and second frames 6, 8 to form the window assembly 1. Specifically, the first and second mullion clip halves 32, 34 may be configured to be mounted upon a pair of recesses 36, 38 formed in the first and second frames 6, 8 to allow for the field construction of the window assembly 1. To facilitate easy installation, the first and second mullion clip halves 32, 34 are configured to snap into engagement with the recess 36, 38. Further, the clip halves 32, 34 may inter-fit with each other to align the first and second frames 6, 8 when the frames are brought together to form the window assembly 1. A pair of snap on covers 40, 42 (FIG. 3) fit over the first and second mullion clip halves 32, 34 to lock the clip halves together, and also to seal the assembly from the weather. The clips also provide an attractive final surface appearance for the connection between the frames 6, 8.

The first and second mullion clip halves 32, 34 are advantageously made from a structural polymer, such as polyvinyl chloride (PVC), or a fiberglass or carbon fiber reinforced composite material of the type well known in the art. Alternatively, the clip halves 32, 34 may be made from metal, such as an aluminum alloy or steel, or a combination of aluminum alloy and steel, or other metals. Each clip half may also have a length that is at least similar to the length of the first and second frames 6, 8. The clip halves 32, 34 may be extruded in over-sized lengths, e.g., fourteen foot lengths, and cut down to fit a wide variety of windows.

The clip halves 32, 34 may have integrally-formed thermal barrier tabs 44, 46 that extend deep into one of the recesses 36, 38. When the clips halves are assembled, these thermal barrier tabs 44, 46 may serve to impede the flow of air from the exterior of the window units to the interior of the units, providing a labyrinthine path for any such air flow, thereby reducing or eliminating drafts between the window units. In the illustrated embodiment, the thermal barrier tabs 44, 46 extend within the recess 38 that is adjacent to the interior surfaces 48, 50 of the first and second frames 6, 8. It will be appreciated, however, that they could also be located within the recess 36 adjacent to the exterior surfaces 52, 54 of the frames 6, 8.

As previously noted, the first mullion clip half 32 is configured to engage the first window frame 6 and the second mullion clip half 34 is configured to engage the second window frame 8. For ease of handling and assembly, each clip half 32, 34 is configured to snap into engagement with window frame recess 36, 38, and thus each half is formed to include a plurality of frame lock tabs configured to snap into engagement with associated depending structures formed in, or adjacent to, the window frame recesses 36, 38.

As shown in FIG. 2A, each of the first and second mullion clip halves 32, 34 has first, second and third frame lock tabs 56, 58, 60 configured to engage respective depending structures 62, 64, 66 of the frames 6, 8. The clip halves 32, 34 are configured to be flexible so that at least a portion of each half can compress or distort slightly during installation to allow one or more of the frame lock tabs to slide past the depending structures 62, 64, 66. Once the halves are seated in the recesses 36, 38, they spring back to lock the tabs behind the depending structures. In this way, the clip halves 32, 34 can be locked to the window units by hand, without the need for tools or fasteners.

In the illustrated embodiment, the first and second frame lock tabs 56, 58 are associated with an exterior portion 70 of each clip half 32, 34, while the third frame lock tab 60 is associated with an interior portion 72 of each clip half 32, 34. The exterior and interior portions 70, 72 of the clip halves 32, 34 are connected by a body member 74, which also carries the thermal barrier tabs 44, 46. This connection between the interior and exterior portions enables one-piece manufacture and installation, reducing total production costs and assembly time.

Referring to FIG. 2B, the first and second frame lock tabs 56, 58 (associated with the exterior portion 70 of each clip half 32, 34) may each have a curved front facing surface 76, 78 and an opposite rear locking surface 80, 82. The curved front facing surface 76, 78 of each tab may be configured to slide easily over the associated depending structures 62, 64 when the tabs 56, 58 are pressed against the depending structures 62, 64. This sliding is aided by the previously mentioned flexibility of the clip halves 32, 24. In one embodiment, this flexibility is provided by first and second flexible arms 84, 86 which connect the first and second frame lock tabs 56, 58 to the exterior portion 70 of each clip half 32, 34. Thus, when the exterior portion 70 of each clip half is pressed into the recess 36 of the associated window frames 6, 8, the arms 84, 86 flex inward to allow the tabs 56, 58 to slide over the depending structures 62, 64. Once the tabs have passed the structures, the spring force inherent in the flexed arms causes them to return to their original configuration, engaging the rear locking surface 80, 82 of each tab with an associated surface of the depending structure 62, 64.

Referring to FIG. 2C, the interior portion 72 of each clip half 32, 34 may lock the clip to recess 38 via third frame lock tab 60 in a manner similar to that described in relation to the exterior portion 70. Thus, the third frame lock tab 60 may have a curved front facing surface 84 and an flat rear surface 86. The curved front facing surface 84 may be configured to slide over the associated depending structure 68 when the interior portion 72 of the clip half 32, 34 is pressed into the recess 38. Alternatively, the third frame lock tab 60 may simply be placed behind the depending structure 68 as a first step in snapping the associated clip half 32, 34 with the associated window frame 6, 8. The clip half 32, 34 may then be pivoted up (using the tab/structure engagement as a fulcrum) until the exterior portions 70 of the clip halves 32, 34 are positioned adjacent to the recesses 36 of the associated window frame 6, 8. The exterior portions 70 may then be snapped into place as previously described.

Thus, to install the clip halves 32, 34 to the frames 6, 8, the exterior and interior portions 70, 72 of each clip may be positioned adjacent to the respective recesses 36, 38 in the window frames 6, 8 until each of the frame lock tabs 56, 58, 60 abuts the associated depending structure 62, 64, 68. Firm pressure applied to the portions 70, 72 may then cause the frame lock tabs 56, 58, 60 to slide on the respective depending structures 62, 64, 68 of the window frames 6, 8, flexing the clip halves in a manner that allows the tabs to pass over the depending structures.

Once the frame lock tabs 56, 58, 60 have passed over the depending structures 62, 64, 68 the clip half may return to its original shape, engaging the rear locking surface 80, 82, 86 of the each tab 56, 58, 60 with the depending structure, locking the clip half 32, 34 within the recess 36, 28.

Alternatively, rather than snapping the interior portion 72 of each clip half 32, 34 into the associated recess 38, the interior portion 72 can be locked to the recess 38 by simply slipping the third frame lock tab 60 behind the associated depending structure 68. The clip halves can then be pivoted around the fulcrum of the tab/structure (60, 68) connection until the exterior portion 72 of each clip half 32, 34 is positioned adjacent to its associated recess 36. The clip halves 32, 34 can then be finally locked to the window frames 6, 8 by snapping the exterior portions 72 into engagement with the associated recess 36 in the manner previously described.

As previously noted, the first and second clip halves 32, 34 may incorporate features that enable precise alignment of the window frames 6, 8. Referring again to FIG. 2A, these alignment features may comprise respective corresponding projections and recesses formed on the exterior and interior portions 70, 72 of each clip half 32, 34. These projections and recesses may configured to contact each other when the first and second window frames 6, 8 frames are brought together to form the window assembly 1.

In the illustrated embodiment, the exterior portion 70 of the first clip half 32 comprises a recess 88 configured to receive a correspondingly shaped projection 90 formed on the exterior portion 70 of the second clip half 34. Likewise, the interior portion 72 of the first clip half 32 has a recess 92 configured to receive a correspondingly shaped projection 94 formed on the interior portion 72 of the second clip half 34. In this way, the mullion clip halves 32, 24 can be used to guide the frames 6, 8 into position with respect to each other, thus ensuring proper alignment of the finished window assembly 1.

In the illustrated embodiment the projections and recesses are shown as having a tapered geometry to enable easier initial alignment and fit-up. It will be appreciated, however, that the projections and recesses can be provided in a variety of other shapes, including square, curved, stepped, and the like.

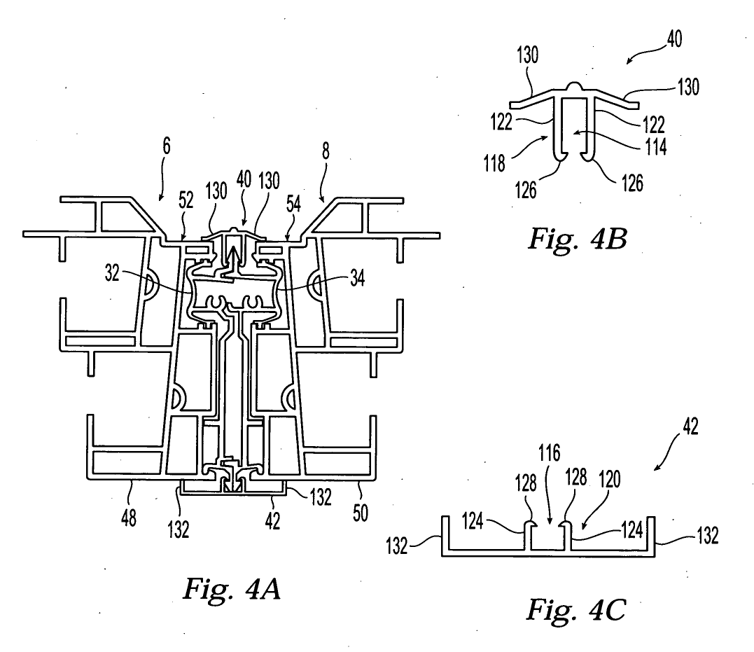

In addition to having features for engaging the window frames 6, 8, the mullion clip halves 32, 34 may also incorporate features for facilitating connection of exterior and interior snap on covers 40, 42 for sealing the gap 96 between the window frames 6, 8 and providing a finished look to the window assembly 1 (FIG. 4A). Thus, the exterior portions 70 of the first and second clip halves 32, 34 may form a barb 98 when joined together. Likewise, the interior portions 72 of the first and second clip halves 32, 34 may form a barb 100 when joined together. Barbs 98, 100 may each comprise a substantially triangular cross-sectional shape, including sloping surfaces 102, 104. Other cross-sectional shapes may also be utilized as long as they provide structure for engaging the associated cover 40, 42. Stem halves 106A, B; 108A, B project from a portion of each barb half 98A, B; 100A, B so as to attach the barb 98, 100 to a portion of each mullion clip half 32, 34. In this way, a pair of shoulders 10A, B; 112A, B are formed adjacent to the sides of stem halves 106A, B; 108A, B.

The barbs 98, 100 may be sized to be received within respective recesses 114, 116 (FIGS. 4B, C) of the exterior and interior snap on covers 40, 42. The covers 40, 42 thus serve to lock the clip halves 32, 34 together and to securely cover the gap 98 between the first and second frames 6, 8, sealing the frame connection from the elements and providing a finished appearance. Each cover may have a clip engaging portion 118, 120 comprising a pair of spaced apart arms 122, 124 defining a recess 114, 116 therebetween. The recess 114, 116 may be configured to receive the barb 98, 100 of the associated interior or exterior mullion clip 32, 34. The clip engaging portion 118, 120 of each cover 40, 42 may comprise a pair of inwardly projecting lips 126, 128 disposed adjacent to the distal end of each arm 122, 124. These lips 126, 128 may engage the associated barb 98, 100 to prevent relative axial movement between the clip and covers when they are fully engaged. In the illustrated embodiment, only a single pair of lips is disposed at the distal end of each arm. It will be appreciated, however, that the arms 122, 124 may be provided with a plurality of such lips or ridges disposed at predetermined intervals along the interior surface of the arms projecting to allow the covers 40, 42 to be engaged with the barbs at a number of different locations along the length of the arms.

Additionally, to ensure efficient sealing of the gap 98 between the frame members 6, 8, the snap on covers 40, 42 each may include a suitably sized pair of laterally extending flanges 130, 132 configured to engage the exterior and interior surfaces 52, 54; 48, 50 of the window frames 6, 8. Thus, when the snap on covers 40, 42 are pressed down over the barbs 98, 100 formed by the clip halves 32, 34, the lips 126, 128 engage the barbs 98, 11 to hold the barb halves together and also to maintain the flange portions in tight engagement with the interior and exterior surfaces of the window frames 6, 8.

In one embodiment, the flange portions 130, 132 are substantially flexible to provide a resilient seal between the covers 40, 42 and the associated window frames 6, 8. To provide an additional degree of sealing between the covers and the frame members, an airtight or watertight adhesive or gasket material may be applied between the covers 40, 42 and the window frame units upon installation.

Thus, the disclosed mullion clips serve to align the window frames 6, 8 during fit-up, and upon installation of the snap on caps, the frames form a combined window assembly 1 that is ready for installation in a home or commercial building without further adjustment. The inventive clip arrangement allows for positive retention of each clip half on the associated frame member without the need for fasteners such as screws. This reduces the time and effort required to install the clips on the frames, and it also eliminates the need to hold the clips against the frames while the adjacent frames are being fit together.

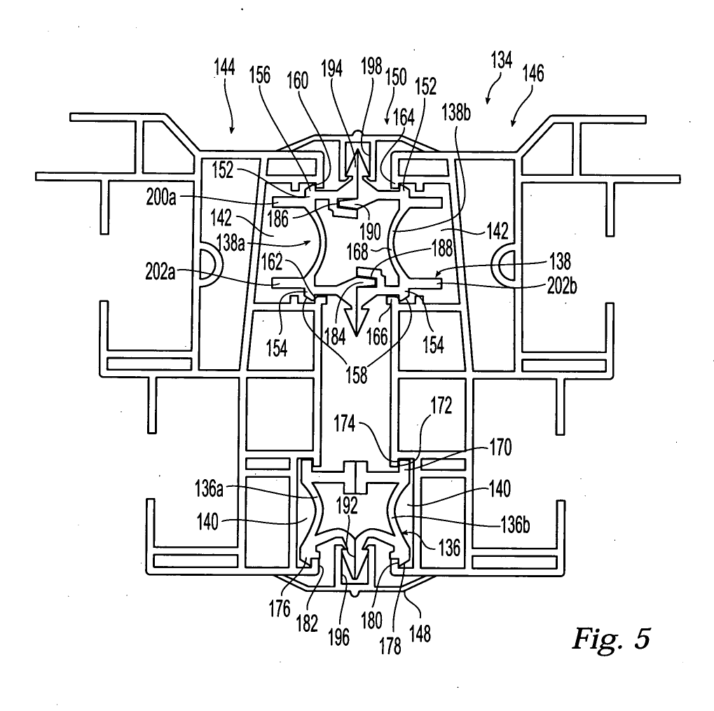

Referring to FIG. 5, an alternative embodiment of the inventive mullion clip assembly is shown. The alternative mullion clip assembly 134 is similar to that described in relation to FIGS. 2A-4C, except that it comprises discrete interior and exterior mullion clips 136, 138 that are not interconnected.

Each of the interior and exterior mullion clips 136, 138 may be provided as a pair of clip halves 136A, B; 138A, B, with each half configured to snap into engagement with a respective recess 140, 142 in the first or second frame 144, 146. The two halves 136A, B of the exterior mullion clip 138 inter-engage with each other so as to align the first and second frames 144, 146 when the frames are brought together to form the window assembly. Similar to the design described in relation to FIGS. 2A-4C, a pair of snap on covers 148, 150 fit over the interior and exterior mullion clips 136, 138 respectively, to lock the clip halves together, and to cover the joint between the first and second frames 144, 146 sealing the connection from the elements and providing an attractive final surface.

The halves of the interior and exterior mullion clips 136, 138 may each snap into engagement with the associated window frame in a manner substantially similar to that described in relation to FIGS. 2A-4C. Thus, each half of the interior and exterior mullion clips 136, 138 may comprise frame lock tabs configured to engage structures adjacent to the recesses in the first and second window frames 144, 146.

In the illustrated embodiment, each half 138A, B of the exterior mullion clip 138 may comprise first and second frame lock tabs 152, 154. The first and second frame lock tabs 152, 154 may each have a curved front facing surface 156, 158 and an opposite rear locking surface 160, 162. As with the previous embodiment, the curved front facing surface 156, 158 of each tab may be configured to slide easily over the associated depending structures 164, 166 of the first and second window frames when the tabs 152, 154 are pressed against the depending structures 164, 166. To facilitate this sliding interaction, a curved flexible body portion 168 is provided between the first and second frame lock tabs 152, 154. Thus, when the clip halves are pressed into the recess 142 of the associated window frame 144, 146, the curved body portion 168 flexes inward to allow the tabs 152, 154 to slide over the depending structures 164, 166. Once the tabs have passed the structures, the spring force inherent in the curved body portion causes the clip half to return to its original configuration, engaging the rear locking surface 160, 162 of each tab with the depending structure 164, 166.

The interior mullion clip 136 may comprise a similar locking arrangement to that of the exterior mullion clip 138, or the locking arrangement may be different. In the illustrated embodiment, each half 136A, B of the interior mullion clip 136 comprises a third frame lock tab 170 having a flat extension surface 172 configured to fit behind a third depending structure 174 of the window frame 144, 146. A fourth frame lock tab 176 may have a curved extension surface 178 on one side and a flat locking surface 180 on the reverse side. The curved extension surface 178 may be configured to slide over the associated depending structure 182 when the tab 176 is pressed against the structure 182, thus causing the clip half to flex by an amount sufficient to allow the tab 176 to pass into the recess 140. To install the halves 136A, B of the interior mullion clip 136 to the window frames 144, 146, the third frame lock tab 170 may be slid behind the third depending structure 174 so that the flat extension surface 172 of the tab 170 abuts the depending structure 174. The fourth frame lock tab 176 may then be pressed against the fourth depending structure 182 so that the curved extension surface 178 engages the structure 182. Pressing the clip half 136A, B hard against the frame 144, 146 causes the clip half to flex (via a curved body portion similar to that of the exterior mullion clip), thereby allowing the curved extension surface 178 to slide over the fourth depending structure. Once the fourth frame lock tab 176 has passed over the fourth depending structure 182, the clip half 136A, B returns to its original shape, and the flat locking surface 180 of the tab 176 engages the third depending structure 182, locking the clip half 136A, B within the associated recess 140.

As with the embodiment of FIGS. 2A-4C, the first and second halves 138A, B of the external mullion clip 138 may comprise corresponding projections and recesses to facilitate alignment of the window frames 144, 146 during assembly. In the illustrated embodiment, the first half 138A comprises a projection 184 and a recess 186 configured to engage a correspondingly shaped recess 188 and projection 190 in the second half 138B. Although the first and second halves 136A, B of the interior mullion clip 136 do not lock together, it is contemplated that similar alignment features to those described in relation to the exterior mullion clip 138 could be provided.

In addition to having features for engaging the window frames 144, 146 the halves of the interior and exterior mullion clips 136, 138 may incorporate features for facilitating connection of interior and exterior snap on covers 148, 150 similar to those previously described. Thus, the halves of the first and second mullion clips 136, 138 may form a barbs 192, 194 when joined together. The barbs 192, 194 may be received within corresponding recesses 196, 198 in the interior and exterior snap-on covers 148, 150 to lock the clip halves together and to seal the gap between the window frames 144, 146.

In addition to the features already described, the exterior mullion clip halves 138A, B may further comprise a pair of integral thermal barrier tabs 200A, B, 202A, B that extend laterally within the associated recess 142 in the window frames 144, 146. When the first and second frames 144, 146 are assembled together, the thermal barrier tabs 200A, B; 202A, B act to block the free flow of air between the window frames 144, 146. In the illustrated embodiment, each half of the exterior mullion clip 138 is provided with a pair of thermal barrier tabs. It will be appreciated that a fewer or greater number of such tabs can be provided as desired.

One advantage of the design described in relation to FIG. 5 is that the halves 136A, B of the interior mullion clip 136 are identical. Likewise, the halves 138A, B of the exterior mullion clip 138 are identical. Such a configuration reduces overall tooling and manufacturing costs associated with production and storage of the mullion halves.

Another benefit of the described four-piece design (separate interior and exterior mullion clips) is that the clips may be used with a multiplicity of window frame sizes, since the clips can be installed virtually any distance apart from each other. Additionally, since the mullion clips snap into place and are retained without screws, they are fast and easy to use. Additionally, as previously noted, providing two discrete clips (exterior and interior) enables the user to select a single clip set for use with a variety of window frame sizes, thus making it easier for the user to stock and use the clips. It also reduces manufacturing costs because only a single size of each clip need be fabricated.

The present invention may be used to form a window assembly 1 in the following manner. Referring again to FIGS. 2A-4C, the mullion clip halves 32, 34 may be snapped into engagement with corresponding portions of frames 6, 8. More particularly, the interior portion 72 of each clip half may be positioned adjacent to recess 38 so that the third frame lock tab 60 of each clip half can be slipped behind depending structure 68 of the associated frame 6, 8. The clip halves 32, 34 may then be pivoted up (using the tab/structure engagement as a fulcrum) until the exterior portions 70 of the clip halves 32, 34 are positioned adjacent to recess 36 of the associated window frame 6, 8. The exterior portions 70 of each clip half 32, 34 may then be pressed against the associated window frame 6, 8 so that the first and second frame lock tabs 56, 58 slide over the first and second depending structures 62, 64, snapping the tabs in place behind the structures. This portion of the process can be performed at the factory during a portion of the window manufacturing process, or at the construction site by the window assembly installers.

Once frames 6, 8 have mullion clip halves 32, 34 fastened to their side surfaces, a window assembly 1 may be formed. More particularly, frames 6, 8 may be aligned such that the projections 90, 94 and recesses 88, 92 of the opposing clip halves 32, 34 are in confronting aligned relation (see FIG. 2A). Once in this position, frames 6, 8 are moved toward one another until the projections 90, 94 are received within the recesses 88, 92 (see FIG. 3A). The arrangement of projections and recesses provides for proper registration and mating of adjacent window frames 6, 8 so as to form a window assembly 1. The mating of the mullion clip halves 32, 34 also forms the thermal barrier (made up of tabs 44, 46) within the recess 38 in the first and second frames 6, 8.

As the complementary halves of the interior and exterior mullion clips 32, 34 are engaged, the complementary portions of the interior and exterior barbs 98, 100, formed on the mullion clip halves 32, 34, are positioned together.

With interior and exterior mullion clips 32, 34 engaged and forming a mullion between window frames 6, 8, snap on covers 40, 42 may be assembled to the mullion clip halves 32, 34 to lock the halves together, and to complete the window assembly 1. Specifically, the exterior snap on cover 40 is first oriented so that lips 126 are positioned in confronting aligned relation with the barb 98. Once in this position, the exterior cover 40 is moved toward the barb 98 until the lips 126 engage the shoulders 110A, B of the barb so as to firmly fasten the exterior cover 40 to the joined clip halves 32, 34. Interior cover 42 is similarly fastened to barb 100.

The window assembly 1 may then fastened to a portion of the building into which it is being installed.

Accordingly, it should be understood that the embodiments disclosed herein are merely illustrative of the principles of the invention. Various other modifications may be made by those skilled in the art which will embody the principles of the invention and fall within the spirit and the scope thereof.

1. A mullion reinforcement for use in forming an assembly of windows comprising:
a first member lockable to a first recess of a first window frame, the first member having first and second projections engageable with first and second structures defining an opening of said first recess to lock said first member to said first recess of said first window frame;
a second member lockable to a first recess of a second window frame, the second member having first and second projections engageable with first and second structures defining an opening of said first recess to lock said second member to said first recess of said second window frame;
wherein the first member further comprises a first portion of a catch and the second member further comprises a second portion of a catch that is complementary to said first portion of a catch so that when the first window frame is assembled to the second window frame said first member and said second member cooperate to form a catch.

2. A mullion of claim 1, wherein said first member comprises an alignment tab and said second member comprises an alignment recess configured to receive said alignment tab when the first and second window frames are assembled together to thereby place the first and second window frames in a predetermined alignment.

3. The mullion of claim 2, wherein said first member comprises an alignment recess and said second member comprises an alignment tab configured to be received within said alignment recess when the first and second window frames are assembled together.

4. The mullion of claim 2, wherein the alignment tab of the first member has a tapered surface configured to be received by a correspondingly tapered surface of the alignment recess in the second member.

5. The mullion of claim 1, further comprising first and second flexible arms connected to the first and second projections of the first member, and third and fourth flexible arms connected to the first and second projections of the second member.

6. The mullion of claim 5, wherein the flexible arms each has a curved cross section.

7. The mullion of claim 1, wherein the catch comprises a barb.

8. The mullion of claim 1, wherein the first member further comprises a first barrier arm oriented to project laterally into the first recess of the first window frame when the first member is locked to the first recess, and the second member further comprises a second barrier arm oriented to project laterally into the first recess of the second window frame when the second member is locked to the first recess of the second window frame.

9. The mullion of claim 8, wherein the first and second barrier arms extend within the first recesses of the first and second window frames to substantially prevent the flow of air between the frames.

10. The mullion of claim 1, wherein the first and second projections of the first member each has a curved face configured to slide over the first and second structures when the first member is pressed against the first and second structures of the first window frame.

11. The mullion of claim 10, wherein the first and second projections of the first member each have a catch face disposed distally from said curved face, said catch face configured to lock against the first and second structures of the first window frame to lock the first member to the first window frame.

12. The mullion of claim 10, wherein the first and second projections of the first member are connected by first and second flexible arms such that the first member is capable of flexing as the curved faces of the first and second projections slide over the first and second structures of the first window frame.

13. The mullion of claim 10, wherein the first and second projections of the second member each has a curved face configured to slide over the first and second structures of the second window frame when the second member is pressed against the first and second structures of the second window frame.

14. The mullion of claim 13, wherein the first and second projections of the second member each have a catch face disposed distally from said curved face, said catch face configured to lock against the first and second structures of the second window frame to lock the second member to the second window frame.

15. The mullion of claim 1, further comprising:
a third member lockable to a second recess of said first window frame, the third member having third and fourth projections engageable with third and fourth structures defining an opening of said second recess to lock said third member to said second recess of said first window frame; and
a fourth member lockable to a second recess of said second window frame, the fourth member having third and fourth projections engageable with third and fourth structures defining an opening of said second recess to lock said fourth member to said second recess of said second window frame;
wherein the third member further comprises a first portion of a second catch and the fourth member further comprises a second portion of a second catch that is complementary to said first portion of said second catch so that when the first window frame is assembled to the second window frame said third and fourth members cooperate to form a second catch.

16. The mullion of claim 15, wherein the third member is connected to the first member via a first body link element and the fourth member is connected to the second member via a second body link element.

17. A mullion assembly, comprising:
a first mullion clip portion lockable to a first recess of a first window frame, the first mullion clip portion having first and second projections engageable with first and second structures defining an opening of the first recess to lock the first mullion clip portion to the first window frame;
a second mullion clip portion lockable to a first recess of a second window frame, the second mullion clip portion having first and second projections engageable with first and second structures defining an opening of the first recess of the second window frame to lock the second mullion clip portion to the second window frame;
wherein the first mullion clip portion further comprises a first catch portion and the second mullion clip portion further comprises a second catch portion complementary to said first catch portion so that when the first window frame is assembled to the second window frame the first and second mullion clip portions cooperate to form a catch.

18. A mullion assembly of claim 17, wherein the first mullion clip portion comprises an abutting surface with an alignment tab and the second mullion clip portion comprises an abutting surface comprising an alignment recess configured to receive said alignment tab when the abutting surfaces of the first and second mullion clip portions are connected together.

19. The mullion assembly of claim 18, wherein the first or second mullion clip portion comprises a second alignment recess and the other of the first or second mullion clip portion comprises a second alignment projection configured to be received within said second alignment recess when the first and second mullion clip portions are connected together.

20. The mullion assembly of claim 18, wherein the alignment tab has a tapered surface configured to be received by a correspondingly tapered surface of the alignment recess.

21. The mullion assembly of claim 17, wherein the first and second projections of the first mullion clip portion are connected by a first body portion, and wherein the first and second projections of the second mullion clip portion are connected by a second body portion.

22. The mullion assembly of claim 17, wherein the catch comprises a barb having first and second sloped surfaces and first and second shoulders disposed opposite the sloped surfaces.

23. The mullion assembly of claim 17, wherein the first mullion clip portion further comprises a first barrier arm oriented to project into the first recess of the first window frame when the first mullion clip portion is locked to the first window frame, and the second mullion clip portion further comprises a second barrier arm oriented to project into the first recess of the second window frame when the second mullion clip portion is locked to the second window frame.

24. The mullion assembly of claim 23, wherein the first and second barrier arms extend within the first recesses of the first and second window frames by a distance sufficient to substantially prevent the flow of air between the frames.

25. The mullion assembly of claim 17, wherein the first and second projections of the first mullion clip portion each has a face surface with a profile configured to slide over the first and second structures when the first mullion clip portion is pressed against the first and second structures of the first window frame.

26. The mullion assembly of claim 25, wherein the first and second projections of the first mullion clip portion each have a catch surface disposed distally from to said face surface, said catch surface configured to lock against the first and second structures of the first window frame to lock the first mullion clip portion to the first window frame.

27. The mullion assembly of claim 25, wherein the first and second projections of the first mullion clip portion are connected by a flexible body portion so that the first mullion clip portion is capable of flexing as the face surfaces of the first and second projections slide over the first and second structures of the first window frame.

28. The mullion assembly of claim 25, wherein the first and second projections of the second member each has a face surface with a profile configured to slide over the first and second structures of the second window frame when the second mullion clip portion is pressed against the first and second structures of the second window frame.

29. The mullion assembly of claim 28, wherein the first and second projections of the second mullion clip portion each have a catch surface disposed opposite to said face surface, said catch surface configured to lock against the first and second structures of the second window frame to lock the second mullion clip portion to the second window frame.

30. The mullion assembly of claim 16, further comprising:
a third mullion clip portion lockable to a second recess of the first window frame, the third mullion clip portion having a third projection engageable with third or fourth structures defining an opening of said second recess to engage said third mullion clip portion to the first window frame;
a fourth mullion clip portion lockable to a second recess of the second window frame, the fourth mullion clip portion having a third projection engageable with third or fourth structures defining an opening of said second recess of the second window frame to engage the fourth mullion clip portion to the second window frame;
wherein the third mullion clip portion further comprises a first portion of a second catch and the fourth mullion clip portion further comprises a second portion of a second catch that is complementary to said first portion of said second catch so that when the first window frame is assembled to the second window frame said third and fourth mullion clip portions cooperate to form a second catch.

31. The mullion assembly of claim 30, wherein the third mullion clip portion is connected to the first mullion clip portion by a first elongated body link.

32. The mullion assembly of claim 31, wherein the fourth mullion clip portion is connected to the second mullion clip portion by a second elongated body link.

33. The mullion assembly of claim 32, wherein the first and second elongated body links are flexible.

34. The mullion assembly of claim 30, wherein the third and fourth mullion clip portions comprise respective third and fourth abutting surfaces configured to contact each other when the third and fourth mullion clip portions are connected, the third and fourth abutting surfaces comprising an a tab/recess combination, the tab configured to be received within a correspondingly shaped surface of the recess.

35. A window assembly, comprising:
a first window having a first window frame;
a second window having a second window frame;
a mullion for connecting the first and second window frames, the mullion comprising: (a) a first mullion clip portion lockable to a first recess of the first window frame via a snap-fit; and (b) a second mullion clip portion lockable to a first recess of a second window frame via a snap-fit; wherein the first and second mullion clip portions further comprise respective first and second complementary catch portions so that when the first window frame is assembled to the second window frame the first and second mullion clip portions cooperate to form a catch; and
a cover configured to engage the catch of the first and second mullion clip portions to lock the halves together and seal a gap between the first and second frames, the cover having first and second spaced apart arms, each arm having a lip disposed on a first end thereof, the lips projecting into a recess defined by the arms for engaging corresponding shoulder regions of the catch when the cover is pressed onto the assembled first and second mullion clip portions.

36. The window assembly of claim 35, wherein the first mullion clip portion has first and second projections engageable with first and second structures defining an opening of the first recess to lock the first mullion clip half to the first window frame and the second mullion clip portion has first and second projections engageable with first and second structures defining an opening of the first recess of the second window frame to lock the second mullion clip portion to the second window frame.

37. A window assembly of claim 36, wherein the first mullion clip portion further comprises an abutting surface with an alignment tab and the second mullion clip half further comprises an abutting surface comprising an alignment recess configured to receive said alignment tab when the abutting surfaces of the first and second mullion clip portions are connected together.

38. The window assembly of claim 37, wherein the alignment tab has a tapered surface configured to be received by a correspondingly tapered surface of the alignment recess.

39. The window assembly of claim 36, wherein the first and second projections of the first mullion clip portion are connected by a first flexible body portion, and wherein the first and second projections of the second mullion clip portion are connected by a second flexible body portion.

40. The window assembly of claim 39, wherein the first and second flexible body portions each has a curved profile.

41. The window assembly of claim 36, wherein the cover further comprises first and second lateral flanges connected to a second end of the first and second spaced apart arms, the lateral flanges configured to seal against exterior surfaces of the first and second window frames.

42. The window assembly of claim 36, wherein the first mullion clip portion further comprises a first barrier arm oriented to project into the first recess of the first window frame when the first mullion clip portion is locked to the first window frame, and the second mullion clip portion further comprises a second barrier arm oriented to project into the first recess of the second window frame when the second mullion clip portion is locked to the second window frame.

43. The window assembly of claim 42, wherein the first and second barrier arms extend within the first recesses of the first and second window frames by a distance sufficient to substantially prevent the flow of air between the frames.

44. The window assembly of claim 36, further comprising:
a third mullion clip portion lockable to a second recess of the first window frame via a snap-fit, and a fourth mullion clip portion lockable to a second recess of the second window frame via a snap-fit; wherein the third mullion clip portion further comprises a first portion of a second catch and the fourth mullion clip portion further comprises a second portion of a second catch that is complementary to said first portion of said second catch so that when the first window frame is assembled to the second window frame said third and fourth mullion clip portions cooperate to form a second catch.

45. The window assembly of claim 44, wherein the third mullion clip portion further comprises a third projection engageable with third or fourth structures defining an opening of said second recess, and the fourth mullion clip portion further comprises a third projection engageable with third or fourth structures defining an opening of said second recess of the second window frame.

46. The window assembly of claim 45, wherein the third mullion clip portion is connected to the first mullion clip portion by a first elongated body link.

47. The window assembly of claim 46, wherein the fourth mullion clip portion is connected to the second mullion clip portion by a second elongated body link.

48. The window assembly of claim 47, wherein the first and second elongated body links are flexible.

49. The window assembly of claim 45, wherein the first and second projections of the first mullion clip portion are connected by a flexible body portion so that the first mullion clip portion is capable of flexing as the face surfaces of the first and second projections slide over the first and second structures of the first window frame.

50. The window assembly of claim 44, further comprising a second cover configured to engage the second catch of the third and fourth mullion clip portions to lock the portions together and seal the gap between the first and second frames.

51. The window assembly of claim 35, wherein the cover further comprises first and second spaced apart arms, each arm having a lip disposed on a first end thereof, the lips projecting into a recess defined by the arms for engaging corresponding shoulder regions of the second catch when the second cover is pressed onto the assembled third and fourth mullion clip portions.

52. A method of assembling a multi-window unit, comprising;
providing first and second window frames, each of the first and second frames comprising first and second recesses;
providing a first mullion clip assembly comprising:
(a) a first member lockable to the first recess of the first window frame, the first member having first and second projections engageable with first and second structures defining an opening of the first recess of the second window frame to lock said first member to said first recess of said first window frame;
(b) a second member lockable to the first recess of the second window frame, the second member having first and second projections engageable with first and second structures defining an opening of the first recess of the second window frame to lock said second member to said first recess of said second window frame;
wherein the first member further comprises a first portion of a catch and the second member further comprises a second portion of a catch that is complementary to said first portion so that when the first window frame is assembled to the second window frame said first member and said second member cooperate to form a catch;
providing a cover comprising first and second spaced apart arms, each arm having a lip disposed on a first end thereof, the lips projecting into a recess defined by the first and second spaced apart arms, the cover further having first and second lateral flanges connected to a second end of the first and second spaced apart arms;
engaging the first member with the first recess of the first window frame;
engaging the second member with the first recess of the second window frame;
moving the first and second window frames together so that the first and second members connect to form the catch;
aligning the first and second spaced apart arms with the catch formed by the first and second members; and
pressing the cover against the catch so until the lips engage the catch and the first and second lateral flanges engage respective outer surfaces of the first and second window frames to seal a gap between the first and second window frames.

53. The method of claim 52, wherein the first and second members comprise respective abutting surfaces configured to contact each other when the first and second window frames are assembled together, wherein one of the abutting surfaces comprising a projection configured to be received within a correspondingly shaped recess in the other abutting surface, and wherein the step of moving the first and second window frames together further comprises aligning the projection with the recess.

54. The method of claim 53, further comprising providing a second mullion clip assembly comprising: a third member lockable to a second recess of said first window frame, the third member having third and fourth projections engageable with third and fourth structures defining an opening of said second recess to lock said third member to said second recess of said first window frame; and a fourth member lockable to a second recess of said second window frame, the fourth member having third and fourth projections engageable with third and fourth structures defining an opening of said second recess to lock said fourth member to said second recess of said second window frame.

55. The method of claim 54, wherein the third member further comprises a first portion of a second catch and the fourth member further comprises a second portion of a second catch that is complementary to said first portion of said second catch such that the step of moving the first and second window frames together forms the second catch.

56. The method of claim 55, further comprising:
providing a second cover comprising first and second spaced apart arms, each arm having a lip disposed on a first end thereof, the lips projecting into a recess defined by the first and second spaced apart arms, the cover further having first and second lateral flanges connected to a second end of the first and second spaced apart arms; and
pressing the second cover against the second catch so until the lips engage the second catch and the first and second lateral flanges engage respective outer surfaces of the first and second window frames to seal a second gap between the first and second window frames.
